(19) United States
(12) Patent Application Publication
(10) Pub. No.: US 2026/0243591 A1
(43) Pub. Date: Aug. 20, 2026

(54) MODULAR CORIOLIS FLOWMETER

(71) Applicant: Endress+Hauser Flowtec AG, Reinach (CH)

(72) Inventors: Marc Werner, Grenzach-Wyhlen (DE); Benjamin Schwenter, Ettingen (CH); Peppino Breda, Liestal (CH); Benjamin Auer, Liestal (CH)

(21) Appl. No.: 19/164,286

(22) PCT Filed: Mar. 5, 2024
(86) PCT No.: PCT/EP2024/055663

§ 371 Date: Sep. 11, 2025

(30) Foreign Application Priority Data
Mar. 13, 2023 (DE) 10 2023 106 215.8

(51) Int. Cl. G01F 1/84; G01F 25/10

(52) U.S. Cl. CPC G01F 1/8413; G01F 1/8422; G01F 1/8477; G01F 25/10

(57) ABSTRACT

A modular Coriolis flowmeter for determining a process variable of a flowable medium includes: a measuring tube module including metal measuring tube for guiding the medium, a primary exciter component arranged on the measuring tube, a primary sensor component arranged on the measuring tube, and an identifier; a carrier module including a receptacle in which the measuring tube module is arranged with a releasable connection in a first or second installation position in a mechanically fixed, yet releasable, manner, an electronics chamber in which evaluation electronics for determining the process variable are arranged, a complementary secondary exciter component, and a complementary secondary sensor component; an installation position recognition device configured to recognize the identifier and, based on this, to ascertain a current installation position, wherein the evaluation electronics are configured to determine the process variable depending on the recognized current installation position.

The invention relates to a modular Coriolis flowmeter for determining a process variable of a flowable medium.

Process measurement technology field devices with a vibration-type sensor and especially Coriolis flowmeters have been known for many years. The basic structure of such a measuring device is described in, for example, EP 1 807 681 A1 , wherein reference is made in full to this publication with respect to the structure of a generic field device in the context of the present invention.

Typically, Coriolis flowmeters have at least one or more vibratable measuring tubes which can be set to vibration by means of a vibration exciter. These vibrations are transmitted along the tube length and are varied by the type of flowable medium located in the measuring tube and by its flow rate. At another point in the measuring tube, a vibration sensor or, in particular, two vibration sensors spaced apart from one another can record the varied vibrations in the form of a measurement signal or a plurality of measurement signals. An evaluation unit can then ascertain the mass throughflow, the viscosity, and/or the density of the medium from the measurement signal(s).

Modular Coriolis flowmeters with interchangeable disposable measuring tube modules are known. For example, in WO 2011/099989 A1 , a method is thus taught for producing a monolithically formed measuring tube arrangement of a Coriolis flowmeter with bent measuring tubes, wherein the measuring tube body for the respective measuring tubes is at first formed as a solid made up of a polymer, and the channel for conducting the flowable medium is subsequently machined into said solid. WO 2011/099989 A1, like U.S. Pat. No. 10,209,113 B2, teaches a connecting body that is configured to receive and support a replaceable measuring tube module with thin-walled plastic tubes. The measuring tube module is fastened, via the connecting body, in a receiving module equipped with the necessary exciters and sensors.

A key characteristic of single-use measuring devices is the recurring commissioning by external operators. This means that a manufacturer's installer is not present during every commissioning, with commissioning of the measuring tube module usually carried out by laypersons instead. One problem that can occur is incorrect positioning of the measuring tube module in the carrier module.

The object of the invention is therefore to provide a user-friendly Coriolis flowmeter.

The object is achieved by the modular Coriolis flowmeter according to claim 1.

The modular Coriolis flowmeter according to the invention for determining a process variable of a flowable medium comprises:
a measuring tube module comprising:
   an, in particular metal, measuring tube for guiding the medium;
   a primary exciter component arranged on the measuring tube,
   a primary sensor component arranged on the measuring tube,
a carrier module comprising:
   a receptacle in which the measuring tube module can be arranged or is arranged with a releasable connection in a first installation position or in a second installation position, which differs from the first installation position, in a mechanically fixed manner and yet able to be released again,
   a secondary exciter component that complements the primary exciter component,
   a secondary sensor component that complements the primary sensor component; and
evaluation electronics for determining the process variable,
   wherein the evaluation electronics are configured to ascertain a current installation position of the measuring tube module in the receptacle,
   wherein the current installation position is either the first installation position or the second installation position,
   wherein the evaluation electronics are configured to determine the process variable taking into account the detected current installation position.

The advantage of automatic installation position detection is that it can ensure correct operation of the modular Coriolis flowmeter. If the current installation position is also included in the ascertainment of the process variable (e.g., by taking into account the installation position when choosing a mathematical formula for determining the process variable, or when choosing a correction factor or a sign), this has the advantage that the process variable can be determined more precisely.

Optionally, the current installation position can also be output to the operator in the form of an installation position signal and/or an installation position indication from the evaluation electronics. If the current installation position deviates from a target installation position, a warning message can be issued, for example, acoustically or visually on a display. Optionally, the operability of the Coriolis flowmeter can be blocked until the current installation position matches the target installation position. Advantageous embodiments of the invention are the subject of the dependent claims.

One embodiment provides for the measuring tube module to comprise a measuring tube module identifier, in particular an optically visible one, which has identification information, wherein the identification information is included in the determination of the current installation position.
One embodiment provides for the carrier module to comprise:
an electronics chamber in which the evaluation electronics are arranged,
an, in particular metal, carrier module wall,
   wherein the carrier module wall defines the electronics chamber and the receptacle,
   wherein the carrier module wall has a through-opening which connects the receptacle to the electronics chamber,
      an optical sensor which is arranged, in particular, in the electronics chamber and is oriented such that when the measuring tube module is arranged in the carrier module, in particular in the receptacle, the optical sensor is directed to a surface of the measuring tube module such that the measuring tube module identifier is detectable for the optical sensor.
One embodiment provides for the measuring tube module to comprise:
a connecting body, in particular of planar design at least in sections, via which a mechanical connection between the measuring tube module and the carrier module is formed and which connects an inlet region of the at least one measuring tube with an outlet region of the at least one measuring tube,
   wherein the measuring tube module identifier is arranged on the connecting body.
One embodiment provides for the identification information to comprise:
information regarding the current installation position.
One embodiment provides for the identification information to comprise:
   a first calibration factor which is assigned to the first installation position, and/or
   a second calibration factor, in particular different from the first calibration factor, which is assigned to the second installation position,
wherein the ascertained current installation position in conjunction with the correspondingly assigned calibration factor is taken into account to determine the process variable.
One embodiment provides for the first and/or the second calibration factor to form a zero point correction with which a measured value provided at the secondary sensor component or a measured variable dependent on the provided measured value is added, or
wherein the first and/or second calibration factor forms a pre-factor with which a measured value provided at the secondary sensor component or a measured variable dependent on the provided measured value is multiplied.
One embodiment provides for the evaluation electronics to be configured to ascertain the process variable by means of the first calibration factor upon recognition of the measuring tube module identifier and to be configured also to ascertain the process variable by means of the second calibration factor if the measuring tube module identifier is not recognized.

If the optical sensor cannot detect the measuring tube module identifier because it is not located at the position assigned to a target installation position, the evaluation electronics can detect this and use the calibration factor assigned to the current installation position, which deviates from the target installation position, to ascertain the process variable.
One embodiment provides for the measuring tube module to have a predetermined flow direction of the medium.

The invention is explained in greater detail with reference to the following figures, in which:

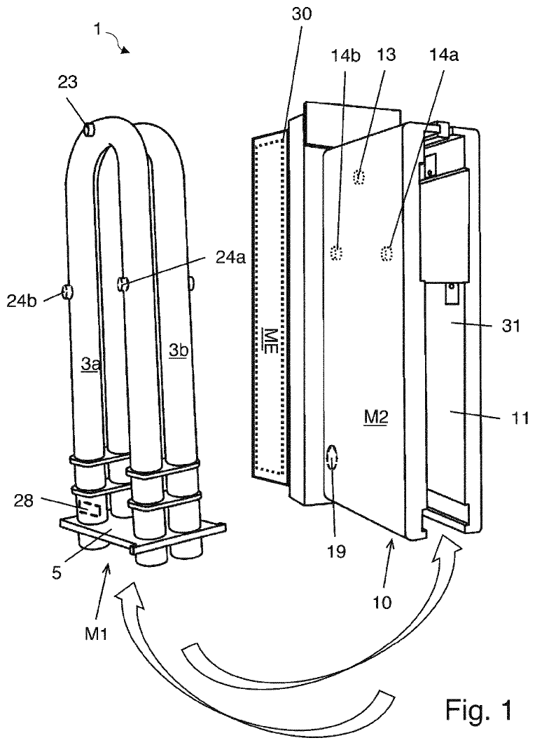

FIG. 1 shows a perspective view of a modular Coriolis flowmeter;

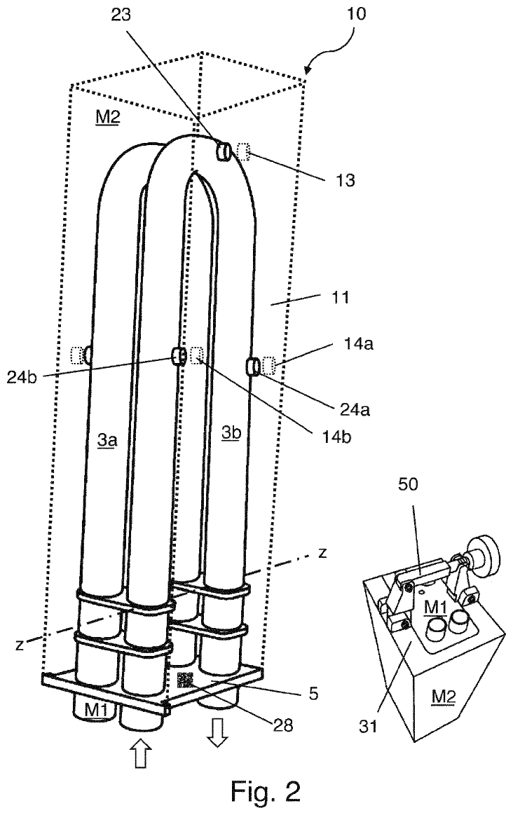

FIG. 2 shows a perspective view of another modular Coriolis flowmeter;

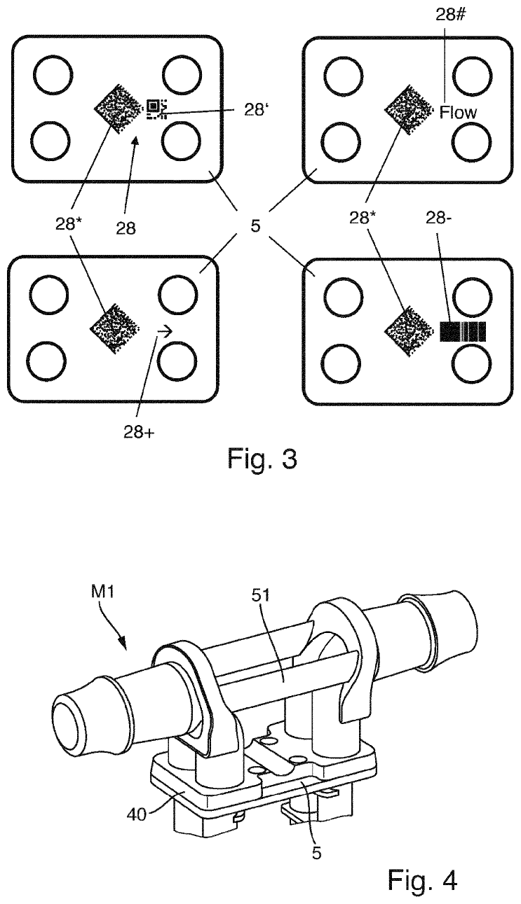

FIG. 3 shows four embodiments of the measuring tube module identifier;

FIG. 4 shows a perspective view of a distributor piece of a modular Coriolis flowmeter; and

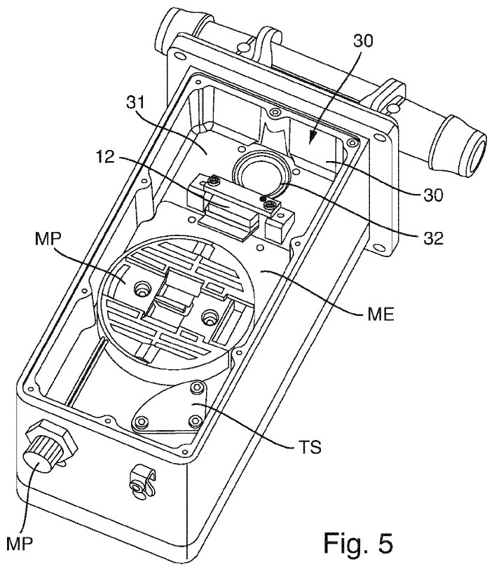

FIG. 5 shows a perspective view of an electronics chamber.

FIG. 1 shows a perspective view of a modular Coriolis flowmeter 1 for determining a process variable of a flowable medium. The Coriolis flowmeter 1 comprises a measuring tube module M1, which has an, in particular metal, measuring tube 3a, 3b for guiding the medium. Alternatively, the measuring tube can also be made of plastic, ceramic and/or glass. In the embodiment shown, the measuring tube module M1 has two bent measuring tubes 3a, 3b, which run parallel to one another at least in sections. The two measuring tubes 3a, 3b are connected to one another via four mechanical, plate-shaped couplers. The measuring tube module M1 shown further comprises a connecting body 5, which in this specific case is planar, via which a mechanical connection between the measuring tube module M1 and the carrier module M2 can be formed or is formed and which connects an inlet region of the at least one measuring tube 3a, 3b with an outlet region of the at least one measuring tube 3a, 3b. In the embodiment shown, the connecting body 5 connects the respective outlet regions of the two measuring tubes 3a, 3b with one another and also with the respective inlet regions. A distributor piece (see FIG. 4), with which the measuring tubes 3a, 3b can be connected to a process line, can be connected to the connecting body 5.

A primary excitation component 23 and a primary sensor component 24a, 24b are arranged on the measuring tube 3a, 3b. In the embodiment shown, a primary excitation component 23 and two primary sensor components 24a, 24b are arranged on each measuring tube 3a, 3b. The primary excitation components 23 and primary sensor components 24a, 24b may each be a permanent magnet.

A measuring tube module identifier 28 is also arranged on an outer surface of one of the measuring tubes 3a, 3b. The measuring tube module identifier 28 is positioned in a measuring tube section between a connecting body 5 and a mechanical coupler, but it can also be arranged at any other position on the measuring tube. The measuring tube module identifier 28 has identification information. The measuring tube module identifier 28 can be a barcode, a QR code, a data matrix code, an OCR font and/or a visual code. A barcode is a strip-shaped code made up of black and white bars that can be scanned by a barcode reader to read information, such as product numbers, prices, and other details. A QR code is a square code that can be read by a QR code scanner to display information, such as URLs, text, contact details, calendar entries and much more. A data matrix code is a two-dimensional code that can store and transmit information similar to a QR code, but is usually smaller and denser than a QR code. A visual code can comprise a single or a plurality of optical identifiers consisting of different geometric shapes (e.g., an arrow or an asymmetric shape) and colors, including color code and others. The identification information can be information regarding the current installation position of the measuring tube module M2. Alternatively or additionally, the identification information can further comprise a first calibration factor which is assigned to the first installation position and/or a second calibration factor, in particular different from the first calibration factor, which is assigned to the second installation position. The first and/or the second calibration factor can each be a zero point correction to which a measured value provided at the secondary sensor component or a measured variable dependent on the provided measured value is added. In this case, the first and/or second calibration factor is an offset with which the measured value measured when the medium is stationary is corrected to zero. Alternatively, the first and/or second calibration factor can be a pre-factor with which a measured value provided at the secondary sensor component or a measured variable dependent on the provided measured value is multiplied.

The Coriolis flowmeter 1 further comprises a carrier module M2 with a receptacle 11 in which the measuring tube module M1 can be arranged or is arranged with a releasable connection in a first installation position or in a second installation position, which differs from the first installation position, in a mechanically fixed manner and yet able to be released again. This means that the measuring tube module M1 can be replaced after each completed process and replaced with a new measuring tube module M1. The two installation positions differ in terms of the orientation of the measuring tube module M1 in the receptacle 11. In the first installation position, the primary excitation component 23 and the primary sensor component 24 face a first side of the receptacle 11, while in the second installation position, said primary excitation component 23 and primary sensor component 24 face a second side facing the first side. Not shown in FIG. 1 (but in FIG. 2) is a fastening device that secures the measuring tube module M1 in place in the receptacle. The receptacle 11 is spatially defined at least in sections by an, in particular metal, carrier module wall 31. The embodiment shown has an opening for the measuring tube module M1, into which it can be inserted into the carrier module M2. The measuring tube module M1 is inserted in the assembly direction, perpendicular to its own longitudinal axis, through the opening and into the receptacle 11.

The carrier module further comprises an electronics chamber 30 in which evaluation electronics ME (shown in dashed lines) are arranged for determining the process variable. The electronics chamber 30 is spatially separated from the receptacle 11 and is spatially defined at least in sections by the carrier module wall 31. The evaluation electronics ME include electronic components that are necessary to carry out calculation operations. The evaluation electronics ME can comprise, for example, a microprocessor and electronic components (for example comprising one or more transistors, one or more electrical resistors, one or more capacitors, one or more mixers, one or more logical electronic components, one or more filters and/or one or more microcontrollers).

The secondary excitation component 13, which is necessary for exciting the measuring tubes 3a, 3b to vibrate and is complementary to the primary excitation component 23, is also part of the carrier module M2. In the present embodiment, the secondary excitation component 13 is an electrical coil which is configured to generate a time-varying magnetic field. Said magnetic field interacts with the magnet arranged on the measuring tube, the first excitation component 23, and causes a force on the measuring tube 3a, 3b. The vibration behavior of the measuring tube 3a, 3b is recorded via a secondary sensor component 14 that is complementary to the primary sensor component 24. The secondary sensor component 14 can also be a coil configured to detect and measure a time-varying magnetic field generated by the primary sensor component 24. The secondary sensor component 14, like the secondary excitation component 23, is also part of the carrier module M2. In the embodiment shown, each primary sensor component 24 is assigned a secondary sensor component 14 and each primary excitation component 23 is assigned a secondary excitation component 13. Thus, the carrier module M2 has four secondary sensor components 14 and two secondary excitation components 13. The two secondary excitation components 13 are each arranged on opposite sides of the receptacle 11. The same applies to the four secondary sensor components 14, wherein two sensor components 14a, 14b are arranged on one side and the two other sensor components (concealed by the wall) are arranged on the opposite side.

Evaluation electronics ME are also part of the carrier module M2, which evaluation electronics ME are configured to recognize the measuring tube module identifier 28, in particular by means of an optical sensor 12, to determine the identification information and, based thereon, to ascertain a current installation position. The evaluation electronics ME are in communication with the optical sensor. The identification information determined by means of the sensor 12, or the detected current installation position, is included in the ascertainment of the process variable or is taken into account when ascertaining the process variable. The identification information can, for example, be readable or interpretable information that indicates that the measuring tube module is arranged in the first installation position. Alternatively, the identification information can comprise readable or interpretable information indicating that the measuring tube module is arranged in the second installation position. It would also be possible for the identification information to comprise two different pieces of information, each arranged at different positions on the measuring tube module. The positioning of the information can be selected such that, depending on the current installation position, the information is or can be read and taken into account with the appropriate stored installation position, for example with an optical sensor.

If the identification information includes the first calibration factor assigned to the first installation position and/or the second calibration factor assigned to the second installation position, the evaluation electronics ME are also configured to read the first calibration factor and/or the second calibration factor and to provide it to the evaluation electronics ME, which are configured to take into account the ascertained current installation position in conjunction with the correspondingly assigned calibration factor when determining the process variable.

The evaluation electronics ME can be arranged in the receptacle 11 itself or in the electronics chamber 30. If the evaluation electronics ME are arranged in the electronics chamber 30, the carrier module wall 31 has a through-opening 32 which connects the receptacle 11 to the electronics chamber 30. If the evaluation electronics ME are an optical sensor 12, said sensor is arranged and oriented in the electronics chamber 30 such that, when the measuring tube module M1 is arranged in the carrier module M2, in particular in the receptacle 11, the optical sensor 12 is directed to a surface of the measuring tube module 4 such that the measuring tube module identifier 28 is detectable for the optical sensor 12 when the measuring tube module M1 is installed.

Additionally or alternatively, the evaluation electronics ME can be configured to ascertain a current zero point value, in particular a current zero point value assigned to a first measuring tube and a current zero point value assigned to a second measuring tube, when the measuring tube module M1 is present in the receptacle 11 and when the flowable medium to be monitored is absent or when the medium is stationary. If the measuring tube module M1 has two measuring tubes 3a, 3b and if a current zero point value can be determined independently for both measuring tubes 3a, 3b, the evaluation electronics ME are configured to determine them for the present arrangement. The evaluation electronics ME are also configured to take into account the current zero point value, in particular the current zero point value assigned to the first measuring tube 3a and the current zero point value assigned to the second measuring tube 3b, and a provided zero point value, in particular with two provided zero point values, when determining the installation position. The provided zero point value can be read optically from the measuring tube module identifier 28 or provided in another way (e.g., via RFID, from a cloud or entered by the operator). Furthermore, the evaluation electronics ME can be configured to signal if the current installation position deviates from a target installation position.

FIG. 2 shows a perspective view of another modular Coriolis flowmeter 10. The Coriolis flowmeter 10 comprises a measuring tube module M1, which has an, in particular metal, measuring tube 3a, 3b for guiding the medium. Alternatively, the measuring tube can also be made of plastic, ceramic and/or glass. In the embodiment shown, the measuring tube module M1 has two bent measuring tubes 3a, 3b, which run parallel to one another at least in sections. The two measuring tubes 3a, 3b are connected to one another via four mechanical, plate-shaped couplers. The measuring tube module M1 shown further comprises a connecting body 5, which in this specific case is planar, via which a mechanical connection between the measuring tube module M1 and the carrier module M2 can be formed or is formed and which connects an inlet region of the at least one measuring tube 3a, 3b with an outlet region of the at least one measuring tube 3a, 3b. In the embodiment shown, the connecting body 5 connects the respective outlet regions of the two measuring tubes 3a, 3b with one another and also with the respective inlet regions. A distributor piece (see FIG. 4) can be connected to the connecting body 5, with which the measuring tubes 3a, 3b can be connected to a process line.

A primary excitation component 23 and a primary sensor component 24a, 24b are arranged on the measuring tube 3a, 3b. In the embodiment shown, a primary excitation component 23 and two primary sensor components 24a, 24b are arranged on each measuring tube 3a, 3b. The primary excitation components 23 and primary sensor components 24a, 24b may each be a permanent magnet.

A measuring tube module identifier 28 is arranged on a surface of the connecting body 5 facing the couplers or the measuring tube bends. The measuring tube module identifier 28 has identification information. The measuring tube module identifier 28 can be a barcode, a QR code (as shown), a data matrix code, an OCR font and/or a visual code. A barcode is a strip-shaped code made up of black and white bars that can be scanned by a barcode reader to read information, such as product numbers, prices, and other details. A QR code is a square code that can be read by a QR code scanner to display information, such as URLs, text, contact details, calendar entries and much more. A data matrix code is a two-dimensional code that can store and transmit information similar to a QR code, but is usually smaller and denser than a QR code. A visual code can comprise a single or a plurality of optical identifiers consisting of different geometric shapes (e.g., an arrow or an asymmetric shape) and colors, including color code and others. The identification information can be information regarding the current installation position of the measuring tube module M2. Alternatively or additionally, the identification information can further comprise a first calibration factor which is assigned to the first installation position and/or a second calibration factor, in particular different from the first calibration factor, which is assigned to the second installation position. The first and/or the second calibration factor can each be a zero point correction to which a measured value provided at the secondary sensor component or a measured variable dependent on the provided measured value is added. In this case, the first and/or second calibration factor is an offset with which the measured value measured when the medium is stationary is corrected to zero. Alternatively, the first and/or second calibration factor can be a pre-factor with which a measured value provided at the secondary sensor component or a measured variable dependent on the provided measured value is multiplied.

The Coriolis flowmeter 1 further comprises a carrier module M2 with a receptacle 11 (shown in dashed lines) in which the measuring tube module M1 can be arranged or is arranged with a releasable connection in a first installation position or in a second installation position, which differs from the first installation position, in a mechanically fixed manner and yet able to be released again. This means that the measuring tube module M1 can be replaced after each completed process and replaced with a new measuring tube module M1. The two installation positions differ in terms of the orientation of the measuring tube module M1 in the receptacle 11. In the first installation position, the primary excitation component 23 and the primary sensor component 24 face a first side of the receptacle 11, while in the second installation position, said primary excitation component 23 and primary sensor component 24 face a second side facing the first side. The carrier module M2 has a fastening device 50 which secures the measuring tube module M1 in place in the receptacle. The fastening device 50 can comprise a single or a plurality of known fastening means, such as screws, clamps, etc. Potential fastening devices are disclosed, for example, in US 2022/0236092 A1, DE 102020127356 A1 and DE 102020114519 A1 . The receptacle 11 is spatially defined at least in sections by an, in particular metal, carrier module wall 31. The embodiment shown has an opening for the measuring tube module M1, into which it can be inserted into the carrier module M2. The measuring tube module M1 is inserted in the assembly direction, parallel to its own longitudinal axis, through the opening and into the receptacle 11.

The carrier module further comprises an electronics chamber 30 in which evaluation electronics ME (shown in dashed lines) are arranged for determining the process variable. The electronics chamber 30 is spatially separated from the receptacle 11 and is spatially defined at least in sections by the carrier module wall 31. The evaluation electronics ME includes electronic components that are necessary to carry out calculation operations. The evaluation electronics ME can comprise, for example, a microprocessor and electronic components (for example comprising one or more transistors, one or more electrical resistors, one or more capacitors, one or more mixers, one or more logical electronic components, one or more filters and/or one or more microcontrollers).

The secondary excitation component 13, which is necessary for exciting the measuring tubes 3a, 3b to vibrate and is complementary to the primary excitation component 23, is also part of the carrier module M2. In the present embodiment, the secondary excitation component 13 is an electrical coil which is configured to generate a time-varying magnetic field. Said magnetic field interacts with the magnet arranged on the measuring tube, the first excitation component 23, and causes a force on the measuring tube 3a, 3b. The vibration behavior of the measuring tube 3a, 3b is recorded via a secondary sensor component 14 that is complementary to the primary sensor component 24. The secondary sensor component 14 can also be a coil configured to detect and measure a time-varying magnetic field generated by the primary sensor component 24. The secondary sensor component 14, like the secondary excitation component 23, is also part of the carrier module M2. In the embodiment shown, each primary sensor component 24 is assigned a secondary sensor component 14 and each primary excitation component 23 is assigned a secondary excitation component 13. Thus, the carrier module M2 has four secondary sensor components 14 and two secondary excitation components 13. The two secondary excitation components 13 are each arranged on opposite sides of the receptacle 11. The same applies to the four secondary sensor components 14, wherein two sensor components 14a, 14b are arranged on one side and the two other sensor components (concealed by the wall) are arranged on the opposite side. Different secondary sensor components 14 are assigned to the primary sensor components 24 depending on the installation position of the measuring tube module in the receptacle.

Evaluation electronics ME are also part of the carrier module M2, which evaluation electronics ME are configured to recognize the measuring tube module identifier 28, to determine the identification information and, based thereon, to ascertain a current installation position. The evaluation electronics ME can be an optical sensor. The identification information thus determined, or the detected current installation position, is included in the ascertainment of the process variable. If the identification information includes the first calibration factor and/or the second calibration factor, the evaluation electronics ME are also configured to read the first calibration factor and/or the second calibration factor and to provide it to the evaluation electronics ME, which are configured to take into account the ascertained current installation position in conjunction with the correspondingly assigned calibration factor when determining the process variable.

The evaluation electronics ME can be arranged in the receptacle 11 itself or in the electronics chamber 30. If the evaluation electronics ME are arranged in the electronics chamber 30, the carrier module wall 31 has a through-opening 32 which connects the receptacle 11 to the electronics chamber 30. If the evaluation electronics ME are an optical sensor 12, it is arranged and oriented in the electronics chamber 30 such that, when the measuring tube module M1 is arranged in the carrier module M2, in particular in the receptacle 11, the optical sensor 12 is directed to a surface of the measuring tube module 4 such that the measuring tube module identifier 28 is detectable for the optical sensor 12 when the measuring tube module M1 is installed.

FIG. 3 shows four embodiments of the optically detectable measuring tube module identifier 28 on a side of the connecting body 5 facing the receptacle. Alternatively, the measuring tube module identifier 28 could always be arranged on a mechanical coupler. The measuring tube module identifier 28 has two codes in all embodiments. A QR code 28* is always arranged centrally on the connecting body. However, it is not necessary to always use two codes. The installation position can be determined also using only one code or more than two codes. The QR code 28* can contain information relating to the measuring tube module M1, such as production number, batch number, etc. The surface on which the QR code 28* is arranged can—when the measuring tube module is arranged in the carrier module—be facing the receptacle or facing away from the receptacle.

In a first embodiment, the measuring tube module identifier 28 has a further QR code 28′, which is positioned offset from the QR code 28*. The QR code 28′ is used to identify a clear installation position of the measuring tube module. For this purpose, information regarding the installation position is stored behind the QR code 28′, or the evaluation electronics are configured to derive an installation position as a function of the QR code 28′. This means that the information about the installation position does not necessarily have to be explicitly stored behind the QR code 28′.

In the second embodiment (to the right of the first embodiment), there is a font code next to the QR code 28*. The font code can be chosen arbitrarily, but must be interpretable by the evaluation electronics. In the present example, the lettering “Flow” is chosen as the font code. The optical sensor reads the font code, the evaluation electronics interpret the font code and derive an installation position therefrom.

In the third embodiment (below the first embodiment), there is a symbol code 28+ next to the QR code 28*. The symbol code 28+ is an arrow. Alternatively, other geometric figures can be chosen, such as a triangle. However, the symbol code 28+ must be interpretable by the evaluation electronics.

In the fourth embodiment (below the second embodiment), there is a barcode 28− next to the QR code 28*. The barcode 28− is a sequence of parallel black bars arranged next to one another and separated by empty spaces. The number of black bars and the distances between them encode the content behind the barcode 28−. The barcode 28 or its content must be interpretable by the evaluation electronics.

FIG. 4 shows a perspective view of a distributor piece 40 of a modular Coriolis flowmeter M1. The distributor piece 40 is part of the measuring tube module M1 and is connected to the connecting body 5. On the distributor piece 40 itself there is a code 51 in the form of an arrow, which indicates a predetermined flow direction for the medium to be guided. The integration of the measuring tube module M1 into a process line must therefore be carried out such that the medium, which is in particular frequently pumped and flowing, enters the measuring tube module M1 through the inlet—to which the beginning of the arrow points—and exits again through the outlet—to which the arrowhead points.

FIG. 5 shows a perspective view of an electronics chamber 30 in which evaluation electronics ME and an optical sensor 12 are arranged. The electronics chamber 30 is separated from the receptacle by a carrier module wall 31. This serves to protect the components in the electronics chamber 30, as it can prevent escaping medium from coming into contact with the electronic components. The carrier module wall 31 has a through-opening in which a transparent window is arranged in a medium-tight manner. The optical sensor 12 is arranged in the electronics chamber 30 such that it can detect and read the measuring tube module identifier 28 through the window. The evaluation electronics ME have a microprocessor MP, a temperature sensor TS and a connection 111 via which the evaluation electronics ME can communicate with an external unit and via which the Coriolis flowmeter is supplied electrically.

1-11. (canceled)

12. A modular Coriolis flowmeter for determining a process variable of a flowable medium, the flowmeter comprising:
a measuring tube module, comprising:
a measuring tube for guiding the medium;
a primary exciter component arranged on the measuring tube; and
a primary sensor component arranged on the measuring tube;
a carrier module, comprising:
a receptacle in which the measuring tube module can be arranged or is arranged with a releasable connection in a first installation position or in a second installation position, which differs from the first installation position, in a mechanically fixed, yet releasable, manner;
a secondary exciter component complementary to the primary exciter component; and
a secondary sensor component complementary to the primary sensor component; and
evaluation electronics configured to determine the process variable,
wherein the evaluation electronics are configured to determine a current installation position of the measuring tube module in the receptacle,
wherein the current installation position corresponds to the first installation position or the second installation position, and
wherein the evaluation electronics are configured to determine the process variable taking into account the determined current installation position.

13. The flowmeter according to claim 12, wherein the measuring tube module includes a measuring tube module identifier, which includes identification information,
wherein the identification information is used in the determination of the current installation position.

14. The flowmeter according to claim 13, wherein the carrier module further includes:
an electronics chamber in which the evaluation electronics are disposed;
a carrier module wall, wherein the carrier module wall defines the electronics chamber and the receptacle, and wherein the carrier module wall includes a through-opening, which connects the receptacle to the electronics chamber; and
an optical sensor disposed in the electronics chamber and oriented such that, when the measuring tube module is arranged in the receptacle of the carrier module, the optical sensor is directed toward a surface of the measuring tube module such that the measuring tube module identifier is detectable by the optical sensor.

15. The flowmeter according to claim 13, wherein the measuring tube module further includes a connecting body configured to mechanically connect the measuring tube module and the carrier module, wherein the connecting body connects an inlet region of the measuring tube with an outlet region of the measuring tube,
wherein the measuring tube module identifier is disposed on the connecting body.

16. The flowmeter according to claim 13, wherein the identification information includes information regarding the current installation position.

17. The flowmeter according to claim 13, wherein the identification information includes:
a first calibration factor, which is assigned to the first installation position; and/or
a second calibration factor, which is different from the first calibration factor, and which is assigned to the second installation position,
wherein the determined current installation position in conjunction with the correspondingly assigned calibration factor of the first or second calibration factors is taken into account to determine the process variable.

18. The flowmeter according to claim 17, wherein the first and/or the second calibration factor forms a zero point correction to which a measured value provided at the secondary sensor component, or a measured variable dependent on the provided measured value, is added, or
wherein the first and/or second calibration factor forms a pre-factor with which a measured value provided at the secondary sensor component, or a measured variable dependent on the provided measured value, is multiplied.

19. The flowmeter according to claim 17, wherein the evaluation electronics are configured to determine the process variable using the first calibration factor upon recognition of the measuring tube module identifier and are further configured to determine the process variable using the second calibration factor when the measuring tube module identifier is not recognized.

20. The flowmeter according to claim 12, wherein the evaluation electronics are configured to determine a current zero point value when the measuring tube module is present in the receptacle and when the flowable medium to be monitored is absent or when the medium is stationary, and
wherein the evaluation electronics are configured to take into account the current zero point value and a provided zero point value when determining the installation position.

21. The flowmeter according to claim 12, wherein:
the measuring tube module includes a first measuring tube and a second measuring tube;
the evaluation electronics are configured to determine a first current zero point value assigned to the first measuring tube and a second current zero point value assigned to the second measuring tube when the measuring tube module is present in the receptacle and when the flowable medium to be monitored is absent or when the medium is stationary; and
the evaluation electronics are configured to take into account the first current zero point value, the second current zero point value, a first provided zero point value assigned to the first measuring tube, and a second provided zero point value assigned to the second measuring tube when determining the installation position.

22. The flowmeter according to claim 12, wherein the measuring tube module is adapted for a predetermined flow direction of the medium.

23. The flowmeter according to claim 12, wherein the evaluation electronics are configured to signal when the current installation position deviates from a target installation position.

24. The flowmeter according to claim 12, wherein the measuring tube module identifier is optically visible.
